(19) United States
(12) Patent Application Publication
(10) Pub. No.: US 2022/0295101 A1
(43) Pub. Date: Sep. 15, 2022

(54) CODING AND DECODING METHODS AND APPARATUSES FOR ADAPTIVE COLOR TRANSFORM AND VIDEO CODEC DEVICE

(71) Applicant: FUJITSU LIMITED, Kawasaki-shi (JP)

(72) Inventors: Wenting CAI, Beijing (CN); Jianqing ZHU, Beijing (CN)

(73) Assignee: FUJITSU LIMITED, Kawasaki-shi (JP)

(21) Appl. No.: 17/826,357

(22) Filed: May 27, 2022

Related U.S. Application Data
(63) Continuation of application No. PCT/CN2019/129191, filed on Dec. 27, 2019.

(51) Int. Cl. H04N 19/61; H04N 19/12; H04N 19/186; H04N 19/159; H04N 19/176; H04N 19/46

(52) U.S. Cl. CPC H04N 19/61; H04N 19/12; H04N 19/186; H04N 19/159; H04N 19/176; H04N 19/46

(57) ABSTRACT

Coding and decoding methods and apparatuses for adaptive color transform and a video codec device. The method includes: determining that a coding unit does not use adaptive color transform when an intra luma prediction mode of the coding unit is a non-regular mode, or determining that the intra luma prediction mode of the coding unit is not the non-regular mode when the coding unit uses adaptive color transform; and coding first indication information indicating whether the intra luma prediction mode of the coding unit is the non-regular mode and/or second indication information indicating whether the coding unit uses the adaptive color transform into a bitstream.

### CROSS-REFERENCE TO RELATED APPLICATIONS

This application is a continuation application, under 35 U.S.C. § 111(a), of International Patent Application No. PCT/CN2019/129191, filed Dec. 27, 2019, in the State Intellectual Property Office of China, the disclosure of which is incorporated herein by reference.

### TECHNICAL FIELD

Embodiments of this disclosure relate to the technical field of video codec.

### BACKGROUND

In the new generation of video coding standard, i.e. Versatile Video Coding (VVC), Adaptive Color Transform (ACT) is used to reduce redundancy between three color components in 444 chroma format, so as to improve coding efficiency of the 444 chroma format. Like HEVC SCC, ACT performs an in-loop color space conversion in a prediction residual domain by adaptively transforming residuals from an input color space into a YCgCo space.

For example, it is possible to adaptively select between two color spaces by informing an ACT flag at a coding unit (CU) level. When the ACT flag is equal to 1, a residual of the CU is encoded in the YCgCo space; otherwise, the residual of the CU is encoded in an original color space.

On the other hand, 67 regular modes are defined in the VVC, including DC, Planar, and 65 angular modes. In addition, the VCC further includes some non-regular modes, such as an intra block copy (IBC) mode, a matrix weighted intra prediction (MIP) mode, and a block differential pulse coded modulation (BDPCM) mode, etc.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

According to an aspect of the embodiments of this disclosure, there is provided a coding apparatus for adaptive color transform. The coding apparatus includes a processor configured to determine that a coding unit does not use adaptive color transform when an intra luma prediction mode of the coding unit is a non-regular mode, or determine that the intra luma prediction mode of the coding unit is not the non-regular mode when the coding unit uses adaptive color transform; and code first indication information indicating whether the intra luma prediction mode of the coding unit is the non-regular mode and/or second indication information indicating whether the coding unit uses the adaptive color transform into a bitstream.

According to another second aspect of the embodiments of this disclosure, there is provided a decoding apparatus for adaptive color transform. The decoding apparatus includes a processor configured to: decode, from a bitstream, first indication information indicating whether an intra luma prediction mode of a decoding unit is a non-regular mode and/or second indication information indicating whether the decoding unit uses adaptive color transform; and determine that the decoding unit does not use adaptive color transform when an intra luma prediction mode of the decoding unit is the non-regular mode, or determine that the intra luma prediction mode of the decoding unit is not the non-regular mode when the decoding unit uses the adaptive color transform.

According to a further aspect of the embodiments of this disclosure, there is provided a video codec device. The video codec device includes a coder configured to determine that a coding unit does not use adaptive color transform when an intra luma prediction mode of the coding unit is an non-regular mode, or determine that the intra luma prediction mode of the coding unit is not the non-regular mode when the coding unit uses adaptive color transform, and code first indication information indicating whether the intra luma prediction mode of the coding unit is the non-regular mode and/or second indication information indicating whether the coding unit uses the adaptive color transform into a bitstream.

The video codec device may also include a decoder configured to decode, from a bitstream, the first indication information and/or the second indication information, and determine that a decoding unit does not use adaptive color transform when an intra luma prediction mode of the decoding unit is the non-regular mode, or determine that the intra luma prediction mode of the decoding unit is not the non-regular mode when the decoding unit uses the adaptive color transform.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is a schematic diagram of decoding after ACT is used;

FIG. 2 is a schematic diagram of the coding method for adaptive color transform of an embodiment of this disclosure;

FIG. 3 is an exemplary diagram of the coding method for adaptive color transform of the embodiment of this disclosure;

FIG. 4 is a schematic diagram of the decoding method for adaptive color transform of an embodiment of this disclosure;

FIG. 5 is a schematic diagram of inferring prediction information in VVC;

FIG. 6 is a schematic diagram of inferring prediction information in the embodiment of this disclosure;

FIG. 7 is a schematic diagram of the coding apparatus for adaptive color transform of an embodiment of this disclosure;

FIG. 8 is a schematic diagram of the decoding apparatus for adaptive color transform of an embodiment of this disclosure; and

FIG. 9 is a schematic diagram of the video codec device of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

It was found by the inventors that similar to the design of HEVC ACT in an existing scheme, for a CU in the inter prediction mode and IBC mode, the ACT is enabled only when there exists at least one non-zero coefficient in the CU; and for a CU in the intra prediction mode, the ACT is enabled only when the chroma component selects an intra prediction mode identical to that of a luma component, i.e. a derived mode (DM).

However, for a CU that adopts the intra prediction mode, if the intra luma prediction mode is a non-regular mode, the chroma DM mode will be set to be a regular mode. Therefore, in these cases, an actual chroma prediction mode is different from a co-located luma prediction mode, and it is not reasonable to apply the ACT to these intra blocks, and a problem of reducing efficiency of coding and decoding will occur.

In order to solve at least one of the above problems, embodiments of this disclosure provide coding and decoding methods and apparatuses for adaptive color transform and a video codec device.

An advantage of the embodiments of this disclosure exists in that the non-regular mode and the adaptive color transform do not operate together, so that a non-regular mode or

ACT may be reasonably applied, performance of each coding and decoding tool may be ensured, and efficiency of coding and decoding may be improved.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

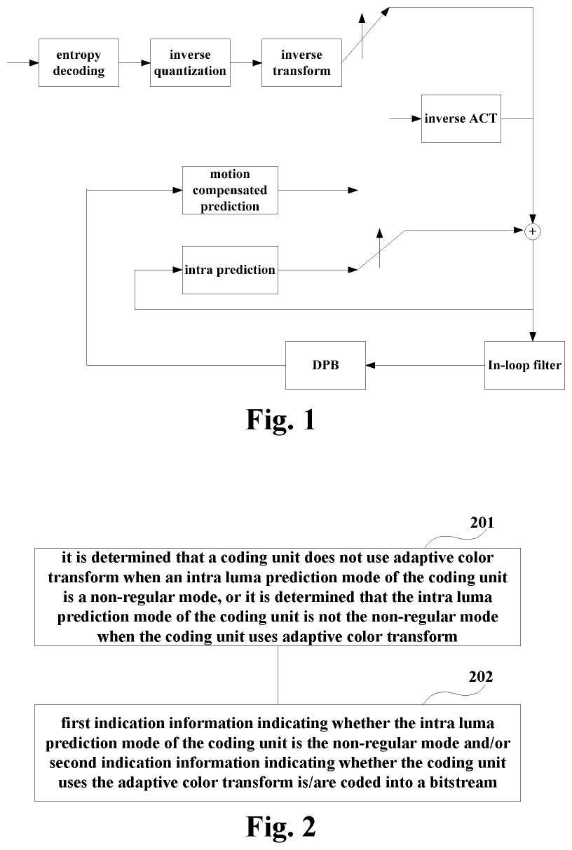

FIG. 1 is a schematic diagram of decoding after ACT is used. As shown in FIG. 1, after performing entropy decoding on a bitstream, a decoding side may perform inverse quantization and inverse transform, and then may perform inverse ACT according to an ACT identifier.

In addition, as shown in FIG. 1, the decoding side may also perform in-loop filter, decoded picture buffer (DPB), intra prediction and motion compensated prediction, etc. FIG. 1 schematically shows various operations of the decoding side, and a coding side may correspondingly perform various operations.

Table 1 schematically shows a chroma mode and a luma mode of an intra prediction mode.

TABLE 1

| Luma mode | Chroma DM mode |
|---|---|
| IBC | DC |
| MIP | Planar |
| BDPCM_VER | VER |
| BDPCM_HOR | HOR |

As shown in Table 1, for example, when the intra luma prediction mode is an IBC mode, the chroma DM mode may possibly be a DC mode; when the intra luma prediction mode is an MIP mode, the chroma DM mode may possibly be a Planar mode; when the intra luma prediction mode is a BDPCM VER mode, the chroma DM mode may possibly be a VER mode; and when the intra luma prediction mode is a BDPCM HOR mode, the chroma DM mode may possibly be an HOR mode.

Therefore, in these cases, an actual chroma prediction mode is different from a co-located luma prediction mode, and if ACT is applied to these inner blocks, it is not reasonable enough, and a problem of reducing efficiency of coding and decoding will occur.

In the embodiments of this disclosure, YCgCo is taken as an example for description; however, this disclosure is not limited thereto, for example, it may also be applicable to other color spaces, such as YCbCr, etc. In addition, the non-regular modes are described by taking IBC, MIP and BDPCM as examples; however, this disclosure is not limited thereto, for example, other non-regular modes may also be used.

### Embodiments of a First Aspect

The embodiments of this disclosure provide a coding method for adaptive color transform. At a coding side, a region of an image to be processed may be referred to as a coding unit (CU) or a coding block (CB); however, this disclosure is not limited thereto, and other names may also be used.

FIG. 2 is a schematic diagram of the coding method for adaptive color transform of the embodiment of this disclosure. As shown in FIG. 2, the method includes:

201: it is determined that a coding unit does not use adaptive color transform when an intra luma prediction mode of the coding unit is a non-regular mode, or it is determined that the intra luma prediction mode of the coding unit is not the non-regular mode when the coding unit uses adaptive color transform; and

202: first indication information indicating whether the intra luma prediction mode of the coding unit is the non-regular mode and/or second indication information indicating whether the coding unit uses the adaptive color transform is/are coded into a bitstream.

It should be noted that FIG. 2 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

In some embodiments, the non-regular mode is a prediction mode other than 67 regular modes in VVC, the 67 regular modes including DC, planar and 65 angle modes. For example, the non-regular mode includes at least one of an IBC mode, an MIP mode or a BDPCM, or any combination thereof; however, this disclosure is not limited thereto.

In some embodiments, the first indication information includes at least one or any combination of the following: intra bdpcm_luma_flag, intra_mip_flag, or pred_mode_ibc_flag; and the second indication information is cu_act_enabled_flag; however, this disclosure is not limited thereto.

Therefore, the non-regular mode and the adaptive color transform do not operate together, so that a non-regular mode or ACT may be reasonably applied, performance of each coding and decoding tool may be ensured, and efficiency of coding and decoding may be improved.

In some embodiments, in a case where the intra luma prediction mode of the coding unit is the non-regular mode and the intra chroma prediction mode is the derived mode DM, it is determined that the coding unit does not use adaptive color transform. In this way, a determination condition for not using ACT may further be refined, and accuracy of determination may be improved.

In some embodiments, the second indication information is not encoded into a bitstream when the intra luma prediction mode of the coding unit is in the non-regular mode. As a result, the number of encoded bits may be lowered, and the coding efficiency may further be improved.

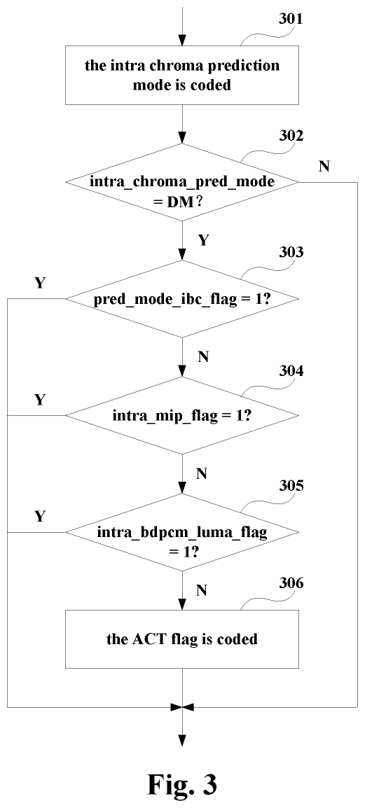

FIG. 3 is an exemplary diagram of the coding method for adaptive color transform of the embodiment of this disclosure, exemplarily showing a part of a coding operation. As shown in FIG. 3, the method includes:

301: the intra chroma prediction mode (intra_chroma_pred_mode) is coded;

302: it is determined whether the intra chroma prediction mode is the DM mode, and it is further determined whether it is the non-regular mode if it is the DM mode.

Taking that IBC, MIP and BDPCM are determined as an example, as shown in FIG. 3, the method further includes:

303: it is determined whether the intra luma prediction mode is the IBC mode, that is, whether pred_mode_ibc_flag is true, and if no, executing 304;

304: it is determined whether the intra luma prediction mode is the MIP mode, that is, whether intra_mip_flag is true, and if no, executing 305;

305: it is determined whether the intra luma prediction mode is the BDPCM mode, that is, whether intra_bdpcm_luma_flag is true, and if no, executing 306; and

306: the ACT flag (cu_act_enabled_flag) is coded into the bitstream.

In FIG. 3, IBC, MIP and BDPCM are taken as examples, and the three non-regular modes are determined sequentially; however, this disclosure is not limited thereto. For example, only one or two of IBC, MIP and BDPCM may be determined, and for another example, an order of determination may be changed, etc. In the example of FIG. 3, the ACT identifier is encoded in the case of not the three non-regular modes, thereby lowering the number of encoded bits.

In some embodiments, in a case where the coding unit does not use the adaptive color transform and the intra chroma prediction mode is the derived mode DM, it is determined that the intra luma prediction mode of the coding unit is not the non-regular mode. Hence, a determination condition for being not a non-regular mode may further be refined, and accuracy of determination may be improved.

In some embodiments, in a case where the coding unit uses adaptive color transform, the first indication information is not encoded into the bitstream. As a result, the number of encoded bits may be lowered, and the coding efficiency may be further improved.

In some embodiments, when third indication information (intra_bdpcm_chroma_flag) indicating a block differential pulse coded modulation (BDPCM) chroma mode is coded, a ratio of a size of the coding unit to a size of a sub-block is taken as a determination condition. The ratio is, for example, cbWidth/SubWidthC and/or cbHeight/SubHeightC, and reference may be made to examples shown in tables 2-8 below for details.

In some embodiments, when the block differential pulse coded modulation BDPCM chroma mode is not enabled or is not selected (i.e. intra_bdpcm_chroma_flag is false), information on a cross component linear mode (CCLM) or other regular modes is coded.

For example, a pair of { } related to intra_bdpcm_chroma_flag in a current video standard document may be deleted, and reference may be made to the examples shown in tables 2-8 below for details.

The embodiment of this disclosure has been schematically described above, and shall be further described below by way of some examples.

In some embodiments, the second indication information may be coded after the intra chroma prediction mode of the coding unit is coded.

Table 2 exemplarily shows a case where the ACT coding is placed after the chroma mode coding, and reference may be made to related video standard documents for detailed meanings of these contents. Furthermore, Table 2 shows differences from existing video standard documents.

```
TABLE 2
      coding_unit( x0, y0, cbWidth, cbHeight, cqtDepth, treeType, modeType ) {
        chType = treeType = = DUAL_TREE_CHROMA ? 1 : 0
        if( slice_type != I | | sps_ibc_enabled_flag ) {
          if( treeType != DUAL_TREE_CHROMA &&
        ( ( !( cbWidth = = 4 && cbHeight = = 4 ) && modeType !=
MODE_TYPE_INTRA )
            | | ( sps_ibc_enabled_flag && cbWidth <= 64 &&
cbHeight <= 64 ) ) )
            cu_skip_flag[ x0 ][ y0 ]
          if( cu_skip_flag[ x0 ][ y0 ] = = 0 && slice_type != I
    && !( cbWidth = = 4 && cbHeight = = 4 ) && modeType = =
MODE_TYPE_ALL )
            pred_mode_flag
          if( ( ( slice_type = = I && cu_skip_flag[ x0 ][ y0 ] = =0 ) | |
          ( slice_type != I && ( CuPredMode[ chType ][ x0 ][ y0 ] !=
MODE_INTRA | |
            ( ( ( cbWidth = = 4 && cbHeight = = 4 ) | | modeType
= = MODE_TYPE_INTRA )
                && cu_skip_flag[ x0 ][ y0 ] = = 0 ) ) ) ) &&
      cbWidth <= 64 && cbHeight <= 64 && modeType !=
MODE_TYPE_INTER &&
      sps_ibc_enabled_flag && treeType != DUAL_TREE_CHROMA )
            pred_mode_ibc_flag
        }
        if( CuPredMode[ chType ][ x0 ][ y0 ] = = MODE_INTRA &&
sps_palette_enabled_flag &&
    cbWidth <= 64 && cbHeight <= 64 &&
cu_skip_flag[ x0 ][ y0 ] = = 0 &&
    modeType != MODE_TYPE_INTER )
            pred_mode_plt_flag
        }
        if( CuPredMode[ chType ][ x0 ][ y0 ] = = MODE_INTRA | |
  CuPredMode[ chType ][ x0 ][ y0 ] = = MODE_PLT ) {
          if( treeType = = SINGLE_TREE | | treeType = =
DUAL_TREE_LUMA ) {
            if( pred_mode_plt_flag ) {
              palette_coding( x0, y0, cbWidth, cbHeight, treeType )
            } else {
              if( sps_bdpcm_enabled_flag &&
            cbWidth <= MaxTsSize && cbHeight <= MaxTsSize)
                intra_bdpcm_luma_flag
              if( intra_bdpcm_luma_flag )
                intra_bdpcm_luma_dir_flag
              else {
                if( sps_mip_enabled_flag)
                  intra_mip_flag[ x0 ][ y0 ]
                if( intra_mip_flag[ x0 ][ y0 ] ) {
                  intra_mip_transposed[ x0 ][ y0 ]
                  intra_mip_mode[ x0 ][ y0 ]
                } else {
                  if( sps_mrl_enabled_flag && ( ( y0 % CtbSizeY ) > 0 ) )
                    intra_luma_ref_idx[ x0 ][ y0 ]
                  if( sps_isp_enabled_flag && intra_luma_ref_idx[ x0 ][ y0 ]
= = 0 &&
              ( cbWidth <= MaxTbSizeY && cbHeight <=
MaxTbSizeY ) &&
              ( cbWidth * cbHeight > MinTbSizeY * MinTbSizeY ) )
                      intra_subpartitions_mode_flag[ x0 ][ y0 ]
                    if( intra_subpartitions_mode_flag[ x0 ][ y0 ] = = 1 )
                      intra_subpartitions_split_flag[ x0 ][ y0 ]
                  if( intra_luma_ref_idx[ x0 ][ y0 ] = = 0 )
                    intra_luma_mpm_flag[ x0 ][ y0 ]
                  if( intra_luma_mpm_flag[ x0 ][ y0 ] ) {
                    if( intra_luma_ref_idx[ x0 ][ y0 ] = = 0 )
                      intra_luma_not_planar_flag[ x0 ][ y0 ]
                    if( intra_luma_not_planar_flag[ x0 ][ y0 ] )
                      intra_luma_mpm_idx[ x0 ][ y0 ]
                  } else
                    intra_luma_mpm_remainder[ x0 ][ y0 ]
                }
              }
            }
          }
          if( ( treeType = = SINGLE_TREE | | treeType = =
DUAL_TREE_CHROMA ) &&
        ChromaArrayType != 0 ) {
            if( pred_mode_plt_flag && treeType = =
DUAL_TREE_CHROMA )
              palette_coding( x0, y0, cbWidth / SubWidthC,
cbHeight / SubHeightC, treeType )
            else {
                if( cbWidth/SubWidthC <= MaxTsSize &&
cbHeight/SubHeightC <= MaxTsSize &&
            sps_bdpcm_chroma_enabled_flag ) [symbol]
                  intra_bdpcm_chroma_flag
                  if( intra_bdpcm_chroma_flag )
                    intra_bdpcm_chroma_dir_flag [symbol]
                else {
                  if( CclmEnabled )
                    cclm_mode_flag
                  if( cclm_mode_flag )
                    cclm_mode_idx
                  else
                    intra_chroma_pred_mode
                      If(intra chroma pred mode == 4 && treeType = =
SINGLE TREE && intra subpartitions mode flag[ x0 ][ y0 ] != 1)
                        cu act enabled flag
                }

[symbol]

            }
          }
        } else if( treeType != DUAL_TREE_CHROMA ) { /* MODE_INTER
or MODE_IBC */
```

Table 3 exemplarily shows a case where the ACT coding is placed after the chroma mode coding and ACT and BDPCM do not operate together, and reference may be made to related video standard documents for detailed meanings of these contents. Furthermore, Table 3 shows differences from existing video standard documents.

```
TABLE 3
      coding_unit( x0, y0, cbWidth, cbHeight, cqtDepth, treeType, modeType ) {
        chType = treeType = = DUAL_TREE_CHROMA ? 1 : 0
        if( slice_type != I | | sps_ibc_enabled_flag ) {
          if( treeType != DUAL_TREE_CHROMA &&
        ( ( !( cbWidth = = 4 && cbHeight = = 4 ) && modeType !=
MODE_TYPE_INTRA )
            | | (sps_ibc_enabled_flag && cbWidth <= 64 &&
cbHeight <= 64 ) ) )
            cu_skip_flag[ x0 ][ y0 ]
          if( cu_skip_flag[ x0 ][ y0 ] = = 0 && slice_type != I
    && !( cbWidth = = 4 && cbHeight = = 4 ) && modeType = =
MODE_TYPE_ALL )
            pred_mode_flag
          if( ( ( slice_type = = I && cu_skip_flag[ x0 ][ y0 ] = =0 ) | |
          ( slice_type != I && ( CuPredMode[ chType ][ x0 ][ y0 ] !=
MODE_INTRA | |
            ( ( ( cbWidth = = 4 && cbHeight = = 4 ) | | modeType
= = MODE_TYPE_INTRA )
                && cu_skip_flag[ x0 ][ y0 ] = = 0 ) ) ) ) &&
      cbWidth <= 64 && cbHeight <= 64 && modeType !=
MODE_TYPE_INTER &&
      sps_ibc_enabled_flag && treeType != DUAL_TREE_CHROMA )
            pred_mode_ibc_flag
        }
        if( CuPredMode[ chType ][ x0 ][ y0 ] = = MODE_INTRA &&
sps_palette_enabled_flag &&
    cbWidth <= 64 && cbHeight <= 64 &&
cu_skip_flag[ x0 ][ y0 ] = = 0 &&
    modeType ! = MODE_TYPE_INTER )
            pred_mode_plt_flag
        }
        if( CuPredMode[ chType ][ x0 ][ y0 ] = = MODE_INTRA | |
  CuPredMode[ chType ][ x0 ][ y0 ] = = MODE_PLT ) {
          if( treeType = = SINGLE_TREE | | treeType = =
DUAL_TREE_LUMA ) {
            if( pred_mode_plt flag ) {
              palette_coding( x0, y0, cbWidth, cbHeight, treeType )
            } else {
              if( sps_bdpcm_enabled_flag &&
            cbWidth <= MaxTsSize && cbHeight <= MaxTsSize)
                intra_bdpcm_luma_flag
              if( intra_bdpcm_luma_flag )
                intra_bdpcm_luma_dir_flag
              else {
                if( sps_mip_enabled_flag)
                  intra_mip_flag[ x0 ][ y0 ]
                if( intra_mip_flag[ x0 ][ y0 ] ) {
                  intra_mip_transposed[ x0 ][ y0 ]
                  intra_mip_mode[ x0 ][ y0 ]
                } else {
                  if( sps_mrl_enabled_flag && ( ( y0 % CtbSizeY ) > 0 ) )
                    intra_luma_ref_idx[ x0 ][ y0 ]
                  if( sps_isp_enabled_flag && intra_luma_ref_idx[ x0 ][ y0 ]
= = 0 &&
              ( cbWidth <= MaxTbSizeY && cbHeight <=
MaxTbSizeY) &&
              ( cbWidth * cbHeight > MinTbSizeY * MinTbSizeY ) )
                    intra_subpartitions_mode_flag[ x0 ][ y0 ]
                  if( intra_subpartitions_mode _flag[ x0 ][ y0 ] = = 1 )
                    intra_subpartitions_split_flag[ x0 ][ y0 ]
                  if( intra_luma_ref_idx[ x0 ][ y0 ] = = 0 )
                    intra_luma_mpm_flag[ x0 ][ y0 ]
                  if( intra_luma_mpm_flag[ x0 ][ y0 ] ) {
                    if( intra_luma_ref_idx[ x0 ][ y0 ] = = 0 )
                      intra_luma_not_planar_flag[ x0 ][ y0 ]
                    if( intra_luma_not_planar_flag[ x0 ][ y0 ] )
                      intra_luma_mpm_idx[ x0 ][ y0 ]
                  } else
                    intra_lum_mpm_remainder[ x0 ][ y0 ]
                }
              }
            }
          }
          if( ( treeType = = SINGLE_TREE | | treeType = =
DUAL_TREE_CHROMA ) &&
        ChromaArrayType != 0 ) {
            if( pred_mode_plt_flag && treeType = =
DUAL_TREE_CHROMA )
              palette_coding( x0, y0, cbWidth / SubWidthC,
cbHeight / SubHeightC, treeType )
            else {
                if( cbWidth/SubWidthC <= MaxTsSize &&
cbHeight/SubHeightC <= MaxTsSize &&
            sps_bdpcm_chroma_enabled_flag ) [symbol]
                  intra_bdpcm_chroma_flag
                  if( intra_bdpcm_chroma_flag )
                    intra_bdpcm_chroma_dir_flag
                else {
                  if( CclmEnabled )
                    cclm_mode_flag
                  if( cclm_mode_flag )
                    cclm_mode_idx
                  else
                    intra_chroma_pred_mode
                      If(intra chroma pred mode == 4 && treeType = =
SINGLE_TREE && !intra_subpartitions_mode_flag[ x0 ][ y0 ]
&& !intra bdpcm luma flag )
                        cu act enabled flag
                }
            }
          }
        } else if( treeType != DUAL_TREE_CHROMA ) { /* MODE_INTER
or MODE_IBC */
```

Table 4 exemplarily shows a case where the ACT coding is placed after the chroma mode coding and ACT and MIP do not operate together, and reference may be made to related video standard documents for detailed meanings of these contents. Furthermore, Table 4 shows differences from existing video standard documents.

```
TABLE 4
      coding_unit( x0, y0, cbWidth, cbHeight, cqtDepth, treeType, modeType ) {
      chType = treeType = = DUAL_TREE_CHROMA ? 1 : 0
      if( slice_type != I | | sps_ibc_enabled_flag ) {
        if( treeType != DUAL_TREE_CHROMA &&
        ( ( !(cbWidth = = 4 && cbHeight = = 4 ) && modeType !=
MODE_TYPE_INTRA )
          | | (sps_ibc_enabled_flag && cbWidth <= 64 &&
cbHeight <= 64 ) ) )
          cu_skip_flag[ x0 ][ y0 ]
        if( cu_skip_flag[ x0 ][ y0 ] = = 0 && slice_type != I
    && !( cbWidth = = 4 && cbHeight = = 4 ) && modeType = =
MODE_TYPE_ALL )
          pred_mode_flag
        if( ( ( slice_type = = I && cu_skip_flag[ x0 ][ y0 ] = =0 ) | |
        (slice_type != I && ( CuPredMode[ chType ][ x0 ][ y0 ] !=
MODE_INTRA | |
          ( ( ( cbWidth = = 4 && cbHeight = = 4 ) | | modeType
= = MODE_TYPE_INTRA )
              && cu_skip_flag[ x0 ][ y0 ] = = 0 ) ) ) ) &&
      cbWidth <= 64 && cbHeight <= 64 && modeType !=
MODE_TYPE_INTER &&
      sps_ibc_enabled_flag && treeType != DUAL_TREE_CHROMA )
          pred_mode_ibc_flag
      }
      if( CuPredMode[ chType ][ x0 ][ y0 ] = = MODE_INTRA &&
sps_palette_enabled_flag &&
    cbWidth <= 64 && cbHeight <= 64 &&
cu_skip_flag[ x0 ][ y0 ] = = 0 &&
    modeType != MODE_TYPE_INTER )
          pred_mode_plt_flag
      }
      if( CuPredMode[ chType ][ x0 ][ y0 ] = = MODE_INTRA | |
  CuPredMode[ chType ][ x0 ][ y0 ] = = MODE_PLT ) {
        if( treeType = = SINGLE_TREE | | treeType = =
DUAL_TREE_LUMA ) {
          if( pred_mode_plt flag ) {
            palette_coding( x0, y0, cbWidth, cbHeight, treeType )
          } else {
            if( sps_bdpcm_enabled_flag &&
          cbWidth <= MaxTsSize && cbHeight <= MaxTsSize)
              intra_bdpcm_luma_flag
            if( intra_bdpcm_luma_flag )
              intra_bdpcm_luma_dir_flag
            else {
              if( sps_mip_enabled_flag)
                intra_mip_flag[ x0 ][ y0 ]
              if( intra_mip_flag[ x0 ][ y0 ] ) {
                intra_mip_transposed[ x0 ][ y0 ]
                intra_mip_mode[ x0 ][ y0 ]
              } else {
                if( sps_mrl_enabled_flag && ( ( y0 % CtbSizeY ) > 0 ) )
                  intra_luma_ref_idx[ x0 ][ y0 ]
                if( sps_isp_enabled_flag && intra_luma_ref_idx[ x0 ][ y0 ]
= = 0 &&
            (cbWidth <= MaxTbSizeY && cbHeight <=
MaxTbSizeY ) &&
            ( cbWidth * cbHeight > MinTbSizeY * MinTbSizeY ) )
                  intra_subpartitions_mode_flag[ x0 ][ y0 ]
                if( intra_subpartitions_mode _flag[ x0 ] [ y0 ] = = 1 )
                  intra_subpartitions_split_flag[ x0 ][ y0 ]
                if( intra_luma_ref_idx[ x0 ][ y0 ] = = 0 )
                  intra_luma_mpm_flag[ x0 ][ y0 ]
                if( intra_luma_mpm_flag[ x0 ][ y0 ] ) {
                  if( intra_luma_ref_idx[ x0 ][ y0 ] = = 0 )
                    intra_luma_not_planar_flag[ x0 ][ y0 ]
                  if( intra_luma_not_planar_flag[ x0 ][ y0 ] )
                    intra_luma_mpm_idx[ x0 ][ y0 ]
                } else
                  intra_luma_mpm_remainder[ x0 ][ y0 ]
              }
            }
          }
        }
        if( ( treeType = = SINGLE_TREE | | treeType = =
DUAL_TREE_CHROMA ) &&
      ChromaArrayType != 0 ) {
          if( pred_mode_plt_flag && treeType = =
DUAL_TREE_CHROMA )
            palette_coding( x0, y0, cbWidth / SubWidthC,
cbHeight / SubHeightC, treeType )
          else {
            if( cbWidth/SubWidthC <= MaxTsSize &&
cbHeight/SubHeightC <= MaxTsSize &&
          sps_bdpcm_chroma_enabled_flag ) [symbol]
                intra_bdpcm_chroma_flag
                if( intra_bdpcm_chroma_flag )
                  intra_bdpcm_chroma_dir_flag
              else {
                if( CclmEnabled )
                  cclm_mode_flag
                if( cclm_mode_flag )
                  cclm_mode_idx
                else
                  intra_chroma_pred_mode
                    If(intra chroma pred mode == 4 && treeType = =
SINGLE_TREE && !intra_subpartitions_mode_flag[ x0 ][ y0 ] &&
!intra mip flag[ x0 ][ y0 ])
                      cu act enabled Has
              }

[symbol]

          }
        }
      } else if( treeType != DUAL_TREE_CHROMA ) { /* MODE_INTER
or MODE_IBC */
```

Table 5 exemplarily shows a case where the ACT coding is placed after the chroma mode coding and ACT, MIP and BDPCM do not operate together, and reference may be made to related video standard documents for detailed meanings of these contents. Furthermore, Table 5 shows differences from existing video standard documents.

```
TABLE 5
      coding_unit( x0, y0, cbWidth, cbHeight, cqtDepth, treeType, modeType ) {
        chType = treeType = = DUAL_TREE_CHROMA ? 1 : 0
        if( slice_type != I | | sps_ibc_enabled_flag ) {
          if( treeType != DUAL_TREE_CHROMA &&
        ( ( !( cbWidth = = 4 && cbHeight = = 4 ) && modeType !=
MODE_TYPE_INTRA )
            | | (sps_ibc_enabled_flag && cbWidth <= 64 &&
cbHeight <= 64 ) ) )
            cu_skip_flag[ x0 ][ y0 ]
          if( cu_skip_flag[ x0 ][ y0 ] = = 0 && slice_type != I
    && !( cbWidth = = 4 && cbHeight = = 4 ) && modeType = =
MODE_TYPE_ALL )
            pred_mode_flag
          if( ( ( slice_type = = I && cu_skip_flag[ x0 ][ y0 ] = =0 ) | |
          ( slice_type != I && ( CuPredMode[ chType ][ x0 ][ y0 ] !=
MODE_INTRA | |
            ( ( ( cbWidth = = 4 && cbHeight = = 4) | | modeType
= = MODE_TYPE_INTRA )
                && cu_skip_flag[ x0 ][ y0 ] = = 0 ) ) ) ) &&
      cbWidth <= 64 && cbHeight <=64 && modeType !=
MODE_TYPE_INTER &&
      sps_ibc_enabled_flag && treeType != DUAL_TREE_CHROMA )
            pred_mode_ibc_flag
        }
        if( CuPredMode[ chType ][ x0 ][ y0 ] = = MODE_INTRA &&
sps_palette_enabled_flag &&
    cbWidth <= 64 && cbHeight <= 64 &&
cu_skip_flag[ x0 ][ y0 ] = = 0 &&
    modeType != MODE_TYPE_INTER )
            pred_mode_plt_flag
        }
        if( CuPredMode[ chType ][ x0 ][ y0 ] = = MODE_INTRA | |
  CuPredMode[ chType ][ x0 ][ y0 ] = = MODE PLT ) {
          if( treeType = = SINGLE_TREE | | treeType = =
DUAL_TREE_LUMA ) {
            if( pred_mode_plt flag ) {
              palette_coding( x0, y0, cbWidth, cbHeight, treeType )
            } else {
              if( sps_bdpcm_enabled_flag &&
            cbWidth <= MaxTsSize && cbHeight <= MaxTsSize)
                intra_bdpcm_luma_flag
              if( intra_bdpcm_luma_flag )
                intra_bdpcm_luma_dir_flag
              else {
                if( sps_mip_enabled_flag)
                  intra_mip_flag[ x0 ][ y0 ]
                if( intra_mip_flag[ x0 ][ y0 ] ) {
                  intra_mip_transposed[ x0 ][ y0 ]
                  intra_mip_mode[ x0 ][ y0 ]
                } else {
                  if( sps_mrl_enabled_flag && ( ( y0 % CtbSizeY ) > 0 ) )
                    intra_luma_ref_idx[ x0 ][ y0 ]
                  if( sps_isp_enabled_flag && intra_luma_ref_idx[ x0 ][ y0 ]
= = 0 &&
              ( cbWidth <= MaxTbSizeY && cbHeight <=
MaxTbSizeY ) &&
              ( cbWidth * cbHeight > MinTbSizeY * MinTbSizeY ) )
                    intra_subpartitions_mode_flag[ x0 ][ y0 ]
                  if( intra_subpartitions_mode _flag[ x0 ] [ y0 ] = = 1 )
                    intra_subpartitions_split_flag[ x0 ][ y0 ]
                  if( intra_luma_ref_idx[ x0 ][ y0 ] = = 0 )
                    intra_luma_mpm_flag[ x0 ][ y0 ]
                  if( intra_luma_mpm_flag[ x0 ][ y0 ] ) {
                    if( intra_luma_ref_idx[ x0 ][ y0 ] = = 0 )
                      intra_luma_not_planar_flag[ x0 ][ y0 ]
                    if( intra_luma_not_planar_flag[ x0 ][ y0 ] )
                      intra_luma_mpm_idx[ x0 ][ y0 ]
                  } else
                    intra_luma_mpm_remainder[ x0 ][ y0 ]
                }
              }
            }
          }
          if( ( treeType = = SINGLE_TREE | | treeType = =
DUAL_TREE_CHROMA ) &&
        ChromaArrayType != 0 ) {
            if( pred_mode_plt flag && treeType = =
DUAL_TREE_CHROMA )
              palette_coding( x0, y0, cbWidth / SubWidthC,
cbHeight / SubHeightC, treeType )
            else {
                if( cbWidth/SubWidthC <= MaxTsSize &&
cbHeight/SubHeightC <= MaxTsSize &&
            sps_bdpcm_chroma_enabled_flag ) [symbol]
                  intra_bdpcm_chroma_flag
                  if( intra_bdpcm_chroma_flag )
                    intra_bdpcm_chroma_dir_flag [symbol]
                else {
                  if( CclmEnabled )
                    cclm_mode_flag
                  if( cclm_mode_flag )
                    cclm_mode_idx
                  else
                    intra_chroma_pred_mode
                      If(intra chroma pred mode == 4 && treeType = =
SINGLE_TREE && !intra_subpartitions_mode_flag[ x0 ][ y0 ] && !
intra mip flag[ x0 ][ y0 ] && !intra bdpcm luma flag )
                        cu act enabled flag
                }
            }
          }
        } else if( treeType != DUAL_TREE_CHROMA ) { /* MODE_INTER
or MODE_IBC */
```

In some embodiments, the second indication information may be coded before the intra luma prediction mode of the coding unit.

Table 6 exemplarily shows a case where the ACT coding is placed before the luma mode coding and ACT and BDPCM do not operate together, and reference may be made to related video standard documents for detailed meanings of these contents. Furthermore, Table 6 shows differences from existing video standard documents.

```
TABLE 6
        coding_unit( x0, y0, cbWidth, cbHeight, cqtDepth, treeType, modeType ) {
          chType = treeType = = DUAL_TREE_CHROMA ? 1 : 0
          if( slice_type != I | | sps_ibc_enabled_flag ) {
            if( treeType != DUAL_TREE_CHROMA &&
          ( ( !( cbWidth = = 4 && cbHeight = = 4 ) && modeType !=
MODE_TYPE_INTRA )
            | | ( sps_ibc_enabled_flag && cbWidth <= 64 &&
cbHeight <= 64 ) ) )
            cu_skip_flag[ x0 ][ y0 ]
          if( cu_skip_flag[ x0 ][ y0 ] = = 0 && slice_type != I
    && !( cbWidth = = 4 && cbHeight = = 4 ) && modeType = =
MODE_TYPE_ALL )
            pred_mode_flag
          if( ( ( slice_type = = I && cu_skip_flag[ x0 ][ y0 ] = =0 ) | |
          ( slice_type != I && ( CuPredMode[ chType ][ x0 ][ y0 ] !=
MODE_INTRA | |
              ( ( ( cbWidth = = 4 && cbHeight = = 4 ) | | modeType
= = MODE_TYPE_INTRA )
                && cu_skip_flag[ x0 ][ y0 ] = = 0 ) ) ) ) &&
      cbWidth <= 64 && cbHeight <= 64 && modeType !=
MODE_TYPE_INTER &&
      sps_ibc_enabled_flag && treeType != DUAL_TREE_CHROMA )
            pred_mode_ibc_flag
        }
        if( CuPredMode[ chType ][ x0 ][ y0 ] = = MODE_INTRA &&
sps_palette_enabled_flag &&
    cbWidth <= 64 && cbHeight <= 64 &&
cu_skip_flag[ x0 ][ y0 ] = = 0 &&
    modeType != MODE_TYPE_INTER )
            pred_mode_plt_flag
        }
        if( CuPredMode[ chType ][ x0 ][ y0 ] = = MODE_INTRA &&
sps_act_enabled_flag &&
  treeType = = SINGLE_TREE )
          cu_act_enabled_flag
        if( CuPredMode[ chType ][ x0 ][ y0 ] = = MODE_INTRA | |
  CuPredMode[ chType ][ x0 ][ y0 ] = = MODE_PLT ) {
          if( treeType = = SINGLE_TREE | | treeType = =
DUAL_TREE_LUMA ) {
            if( pred_mode_plt flag ) {
              palette_coding( x0, y0, cbWidth, cbHeight, treeType )
            } else {
              if( sps_bdpcm_enabled_flag &&
            cbWidth <= MaxTsSize && cbHeight <= MaxTsSize
&& ! cu act enabled flag)
                intra_bdpcm_luma_flag
              if( intra_bdpcm_luma_flag )
                intra_bdpcm_luma_dir_flag
              else {
                if( sps_mip_enabled_flag)
                  intra_mip_flag[ x0 ][ y0 ]
                if( intra_mip_flag[ x0 ][ y0 ] ) {
                  intra_mip_transposed[ x0 ][ y0 ]
                  intra_mip_mode[ x0 ][ y0 ]
                } else {
                  if( sps_mrl_enabled_flag && ( ( y0 % CtbSizeY ) > 0 ) )
                    intra_luma_ref_idx[ x0 ][ y0 ]
                  if( sps_isp_enabled_flag && intra_luma_ref_idx[ x0 ][ y0 ]
= = 0 &&
              ( cbWidth <= MaxTbSizeY && cbHeight <=
MaxTbSizeY ) &&
              ( cbWidth * cbHeight > MinTbSizeY * MinTbSizeY ) &&
! cu_act_enabled_flag )
                    intra_subpartitions_mode_flag[ x0 ][ y0 ]
                  if( intra_subpartitions_mode_flag[ x0 ][ y0 ] = = 1 )
                    intra_subpartitions_split_flag[ x0 ][ y0 ]
                  if( intra_luma_ref_idx[ x0 ][ y0 ] = = 0 )
                    intra_luma_mpm_flag[ x0 ][ y0 ]
                  if( intra_luma_mpm_flag[ x0 ][ y0 ] ) {
                    if( intra_luma_ref_idx[ x0 ][ y0 ] = = 0 )
                      intra_luma_not_planar_flag[ x0 ][ y0 ]
                    if( intra_luma_not_planar_flag[ x0 ][ y0 ] )
                      intra_luma_mpm_idx[ x0 ][ y0 ]
                  } else
                    intra_luma_mpm_remainder[ x0 ][ y0 ]
                }
              }
            }
          }
          if( ( treeType = = SINGLE_TREE | | treeType = =
DUAL_TREE_CHROMA ) &&
        ChromaArrayType != 0 ) {
            if( pred_mode_plt_flag && treeType = =
DUAL_TREE_CHROMA )
              palette_coding( x0, y0, cbWidth / SubWidthC,
cbHeight / SubHeightC, treeType )
            else {
              if( !cu_act_enabled_flag ) {
                if( cbWidth/SubWidthC <= MaxTsSize &&
cbHeight/SubHeightC <= MaxTsSize &&
            sps_bdpcm_chroma_enabled_flag ) [symbol]
                  intra_bdpcm_chroma_flag
                  if( intra_bdpcm_chroma_flag )
                    intra_bdpcm_chroma_dir_flag
                else {
                  if( CclmEnabled )
                    cclm_mode_flag
                  if( cclm_mode_flag )
                    cclm_mode_idx
                  else
                    intra_chroma_pred_mode
                }
              }
            }
          }
        } else if( treeType != DUAL_TREE_CHROMA ) { /* MODE_INTER
or MODE_IBC */
```

Table 7 exemplarily shows a case where the ACT coding is placed before the luma mode coding and ACT and MIP do not operate together, and reference may be made to related video standard documents for detailed meanings of these contents. Furthermore, Table 7 shows differences from existing video standard documents.

```
TABLE 7
      coding_unit( x0, y0, cbWidth, cbHeight, cqtDepth, treeType, modeType ) {
        chType = treeType = = DUAL_TREE_CHROMA ? 1 : 0
        if( slice_type != I | | sps_ibc_enabled_flag ) {
          if( treeType != DUAL_TREE_CHROMA &&
        ( ( !( cbWidth = = 4 && cbHeight = = 4 ) && modeType !=
MODE_TYPE_INTRA )
            | | ( sps_ibc_enabled_flag && cbWidth <= 64 &&
cbHeight <= 64 ) ) )
            cu_skip_flag[ x0 ][ y0 ]
          if( cu_skip_flag[ x0 ][ y0 ] = = 0 && slice_type != I
    && !( cbWidth = = 4 && cbHeight = = 4 ) && modeType = =
MODE_TYPE_ALL )
            pred_mode_flag
          if( ( ( slice_type = = I && cu_skip_flag[ x0 ][ y0 ] = =0 ) | |
          ( slice_type != I && ( CuPredMode[ chType ][ x0 ][ y0 ] !=
MODE_INTRA | |
              ( ( ( cbWidth = = 4 && cbHeight = = 4 ) | | modeType
= = MODE_TYPE_INTRA )
                && cu_skip_flag[ x0 ][ y0 ] = = 0 ) ) ) ) &&
      cbWidth <= 64 && cbHeight <= 64 && modeType !=
MODE_TYPE_INTER &&
      sps_ibc_enabled_flag && treeType != DUAL_TREE_CHROMA )
            pred_mode_ibc_flag
        }
        if( CuPredMode[ chType ][ x0 ][ y0 ] = = MODE_INTRA &&
sps_palette_enabled_flag &&
    cbWidth <= 64 && cbHeight <= 64 &&
cu_skip_flag[ x0 ][ y0 ] = = 0 &&
    modeType != MODE_TYPE_INTER )
            pred_mode_plt_flag
        }
        if( CuPredMode[ chType ][ x0 ][ y0 ] = = MODE_INTRA &&
sps_act_enabled_flag &&
  treeType = = SINGLE_TREE)
          cu_act_enabled_flag
        if( CuPredMode[ chType ][ x0 ][ y0 ] = = MODE_INTRA | |
  CuPredMode[ chType ][ x0 ][ y0 ] = = MODE_PLT ) {
          if( treeType = = SINGLE_TREE | | treeType = =
DUAL_TREE_LUMA ) {
            if( pred_mode_plt_flag ) {
              palette_coding( x0, y0, cbWidth, cbHeight, treeType )
            } else {
              if( sps_bdpcm_enabled_flag &&
            cbWidth <= MaxTsSize && cbHeight <= MaxTsSize)
                intra_bdpcm_luma_flag
              if( intra_bdpcm_luma_flag )
                intra_bdpcm_luma_dir_flag
              else {
                if( sps_mip_enabled_flag && ! cu act enabled flag )
                  intra_mip_flag[ x0 ][ y0 ]
                if( intra_mip_flag[ x0 ][ y0 ] ) {
                  intra_mip_transposed[ x0 ][ y0 ]
                intra_mip_mode[ x0 ][ y0 ]
                } else {
                  if( sps_mrl_enabled_flag && ( ( y0 % CtbSizeY ) > 0 ) )
                    intra_luma_ref_idx[ x0 ][ y0 ]
                  if( sps_isp_enabled_flag && intra_luma_ref_idx[ x0 ][ y0 ]
= = 0 &&
              ( cbWidth <= MaxTbSizeY && cbHeight <=
MaxTbSizeY ) &&
              ( cbWidth * cbHeight > MinTbSizeY * MinTbSizeY ) &&
!cu_act_enabled_flag )
                    intra_subpartitions_mode_flag[ x0 ][ y0 ]
                if( intra_subpartitions_mode_flag[ x0 ] [ y0 ] = = 1 )
                    intra_subpartitions_split_flag[ x0 ][ y0 ]
                  if( intra_luma_ref_idx[ x0 ][ y0 ] = = 0 )
                    intra_luma_mpm _flag[ x0 ][ y0 ]
                  if( intra_luma_mpm_flag[ x0 ][ y0 ] ) {
                    if( intra_luma_ref_idx[ x0 ][ y0 ] = = 0 )
                      intra_luma_not_planar_flag[ x0 ][ y0 ]
                    if( intra_luma_not_planar_flag[ x0 ][ y0 ] )
                      intra_luma_mpm_idx[ x0 ][ y0 ]
                  } else
                    intra_luma_mpm_remainder[ x0 ][ y0 ]
                }
              }
            }
          }
          if( ( treeType = = SINGLE_TREE | | treeType = =
DUAL_TREE_CHROMA ) &&
        ChromaArrayType != 0 ) {
            if( pred_mode_plt_flag && treeType = =
DUAL_TREE_CHROMA )
              palette_coding( x0, y0, cbWidth / SubWidthC,
cbHeight / SubHeightC, treeType )
            else {
              if( !cu_act_enabled_flag ) {
                if( cbWidth/SubWidthC <= MaxTsSize &&
cbHeight/SubHeightC <= MaxTsSize &&
            sps_bdpcm_chroma_enabled_flag ) [symbol]
                  intra_bdpcm_chroma_flag
                  if( intra_bdpcm_chroma_flag )
                    intra_bdpcm_chroma_dir_flag [symbol]
                else {
                  if( cclmEnabled )
                    cclm_mode_flag
                  if( cclm_mode_flag )
                    cclm_mode_idx
                  else
                    intra_chroma_pred_mode
                }
              }
            }
          }
        } else if( treeType != DUAL_TREE_CHROMA ) { /* MODE_INTER
or MODE_IBC */
```

Table 8 exemplarily shows a case where the ACT coding is placed before the luma mode coding and ACT, MIP and BDPCM do not operate together, and reference may be made to related video standard documents for detailed meanings of these contents. Furthermore, Table 8 shows differences from existing video standard documents.

```
TABLE 8
      coding_unit( x0, y0, cbWidth, cbHeight, cqtDepth, treeType, modeType ) {
        chType = treeType = = DUAL_TREE_CHROMA ? 1 : 0
        if( slice_type != I | | sps_ibc_enabled_flag ) {
          if( treeType ! = DUAL_TREE_CHROMA &&
        ( ( !( cbWidth = = 4 && cbHeight = = 4 ) && modeType !=
MODE_TYPE_INTRA )
            | | ( sps_ibc_enabled_flag && cbWidth <= 64 &&
cbHeight <= 64 ) ) )
            cu_skip_flag[ x0 ][ y0 ]
          if( cu_skip_flag[ x0 ][ y0 ] = = 0 && slice_type != I
    &&!( cbWidth = = 4 && cbHeight = = 4) && modeType = =
MODE_TYPE_ALL )
            pred_mode_flag
          if( ( ( slice_type = = I && cu_skip_flag[ x0 ][ y0 ] = =0 ) | |
          ( slice_type != I && ( CuPredMode[ chType ][ x0 ][ y0 ] ! =
MODE_INTRA | |
              ( ( ( cbWidth = = 4 && cbHeight = = 4 ) | | modeType
= = MODE_TYPE_INTRA )
                && cu_skip_flag[ x0 ][ y0 ] = = 0 ) ) ) ) &&
      cbWidth <= 64 && cbHeight <= 64 && modeType !=
MODE_TYPE_INTER &&
      sps_ibc_enabled_flag && treeType != DUAL_TREE_CHROMA )
            pred_mode_ibc_flag
        }
        if( CuPredMode[ chType ][ x0 ][ y0 ] = = MODE_INTRA &&
sps_palette_enabled_flag &&
    cbWidth <= 64 && cbHeight <= 64 &&
cu_skip_flag[ x0 ][ y0 ] = = 0 &&
    modeType != MODE_TYPE_INTER )
            pred_mode_plt_flag
        }
        if( CuPredMode[ chType ][ x0 ][ y0 ] = = MODE_INTRA &&
sps_act_enabled_flag &&
  treeType = = SINGLE_TREE )
          cu_act_enabled_flag
          if( CuPredMode[ chType ][ x0 ][ y0 ] = = MODE_INTRA | |
  CuPredMode[ chType ][ x0 ][ y0 ] = = MODE_PLT ) {
          if( treeType = = SINGLE_TREE | | treeType = =
DUAL_TREE_LUMA ) {
            if( pred_mode_plt_flag ) {
              palette_coding( x0, y0, cbWidth, cbHeight, treeType )
            } else {
              if( sps_bdpcm_enabled_flag &&
            cbWidth <= MaxTsSize && cbHeight <= MaxTsSize && !
cu act enabled flag)
                intra_bdpcm_luma_flag
              if( intra_bdpcm_luma_flag )
                intra_bdpcm_luma_dir_flag
              else {
                if( sps_mip_enabled_flag && ! cu act enabled flag )
                  intra_mip_flag[ x0 ][ y0 ]
                if( intra_mip_flag[ x0 ][ y0 ] ) {
                  intra_mip_transposed[ x0 ][ y0 ]
                  intra_mip_mode[ x0 ][ y0 ]
                } else {
                  if( sps_mrl_enabled_flag && ( ( y0 % CtbSizeY ) > 0 ) )
                    intra_luma_ref_idx[ x0 ][ y0 ]
                  if( sps_isp_enabled_flag && intra_luma_ref_idx[ x0 ][ y0 ]
= = 0 &&
              ( cbWidth <= MaxTbSizeY && cbHeight <=
MaxTbSizeY )  &&
              ( cbWidth * cbHeight > MinTbSizeY * MinTbSizeY ) &&
!cu_act_enabled_flag )
                    intra_subpartitions_mode_flag[ x0 ][ y0 ]
                  if( intra_subpartitions_mode _flag[ x0 ][ y0 ] = = 1 )
                    intra_subpartitions_split_flag[ x0 ][ y0 ]
                  if( intra_luma_ref_idx[ x0 ][ y0 ] = = 0 )
                    intra_luma_mpm _flag[ x0 ][ y0 ]
                  if( intra_luma_mpm_flag[ x0 ][ y0 ] ) {
                    if( intra_luma_ref_idx[ x0 ][ y0 ] = = 0 )
                      intra_luma_not_planar_flag[ x0 ][ y0 ]
                    if( intra_luma_not_planar_flag[ x0 ][ y0 ] )
                      intra_luma_mpm_idx[ x0 ][ y0 ]
                  } else
                    intra_luma_mpm_remainder[ x0 ][ y0 ]
                }
              }
            }
          }
          if( ( treeType = = SINGLE_TREE | | treeType = =
DUAL_TREE_CHROMA ) &&
        ChromaArrayType != 0 ) {
            if( pred_mode_plt_flag && treeType = =
DUAL_TREE_CHROMA )
              palette_coding( x0, y0, cbWidth / SubWidthC,
cbHeight / SubHeightC, treeType )
            else {
              if( !cu_act_enabled_flag ) {
                if( cbWidth/SubWidthC <= MaxTsSize &&
cbHeight/SubHeightC <= MaxTsSize &&
            sps_bdpcm_chroma_enabled_flag ) [symbol]
                  intra_bdpcm_chroma_flag
                  if( intra_bdpcm_chroma_flag )
                    intra_bdpcm_chroma_dir_flag
                else {
                  if( CclmEnabled )
                    cclm_mode_flag
                  if( cclm_mode_flag )
                    cclm_mode_idx
                  else
                    intra_chroma_pred_mode
                }
              }
            }
          }
        } else if( treeType != DUAL_TREE_CHROMA ) { /* MODE_INTER
or MODE_IBC */
```

It should be noted that the embodiments of this disclosure are exemplarily described above by taking tables 2-8 as examples only; however, this disclosure is not limited thereto. Furthermore, other operations or processes, such as entropy coding, quantization, and transform, etc., may also be included for image coding and the like, and reference may be made to related technologies for detailed contents of these operations or processes.

Variables SubWidthC and SubHeightC in tables 2-8 may be particularly dependent on a chroma format sample structure, which is specified by chroma_format_idc and separate colour plane flag, for example, as shown in Table 9. However, this disclosure is not limited thereto, for example, chroma_format_idc, SubWidthC and SubHeightC may also be specified as other values.

TABLE 9

| chroma_for- | separate_colour_ | Chroma | Sub | Sub |
|---|---|---|---|---|
| mat_idc | plane_flag | format | WidthC | HeightC |
| 0 | 0 | Mono- | 1 | 1 |
| | | chrome | | |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

It should be noted that SubWidthC and SubHeightC in the embodiments of this disclosure are exemplarily described above by taking Table 9 as an example; however, this disclosure is not limited thereto, and reference may be made to related video coding and decoding standard documents for specific contents of these parameters.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiments that the non-regular mode and the adaptive color transform in this disclosure do not operate together, so that a non-regular mode or ACT may be reasonably applied, performance of each coding and decoding tool may be ensured, and efficiency of coding and decoding may be improved.

### Embodiments of a Second Aspect

The embodiments of this disclosure provide a decoding method for adaptive color transform, with contents identical to those in the embodiments of the first aspect being not going to be described herein any further. At a decoding side, for the sake of convenience, a region of an image to be processed may be referred to as a decoding unit; however, this disclosure is not limited thereto, for example, it may also be referred to as a coding unit (CU) or a coding block (CB).

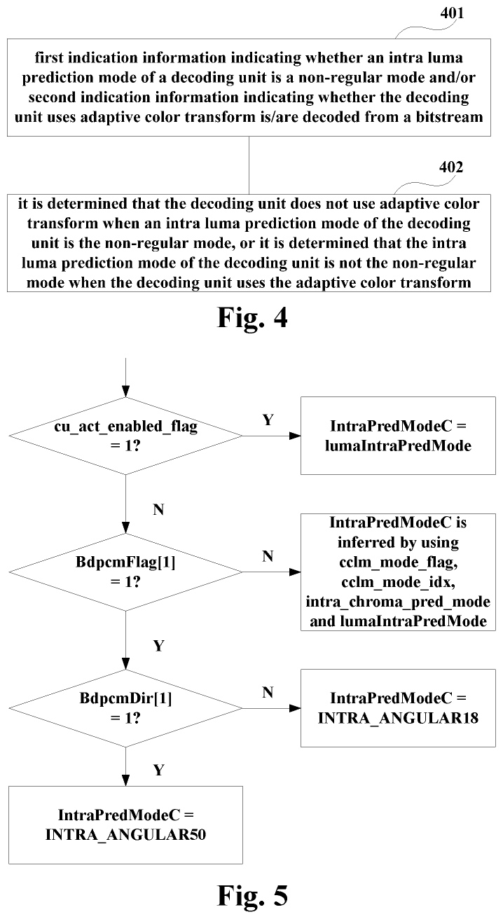

FIG. 4 is a schematic diagram of the decoding method for adaptive color transform of the embodiment of this disclosure. As shown in FIG. 4, the method includes:

401: first indication information indicating whether an intra luma prediction mode of a decoding unit is a non-regular mode and/or second indication information indicating whether the decoding unit uses adaptive color transform is/are decoded from a bitstream; and

402: it is determined that the decoding unit does not use adaptive color transform when an intra luma prediction mode of the decoding unit is the non-regular mode, or it is determined that the intra luma prediction mode of the decoding unit is not the non-regular mode when the decoding unit uses the adaptive color transform.

In some embodiments, the non-regular mode is a prediction mode other than 67 regular modes in VVC, the 67 regular modes including DC, planar and 65 angle modes. For example, the non-regular mode includes at least one of an intra block copy (IBC) mode, a matrix weighted intra prediction (MIP) mode or a block differential pulse coded modulation (BDPCM) mode, or any combination thereof.

In some embodiments, the first indication information includes at least one or any combination of the following: intra_bdpcm_luma_flag, intra_mip_flag, or pred_mode_ibc_flag; and the second indication information is cu_act_enabled_flag.

In some embodiments, the second indication information is decoded before decoding the intra luma prediction mode of the decoding unit.

In some embodiments, the second indication information is decoded after decoding an intra chroma prediction mode of the decoding unit.

In some embodiments, the second indication information is not decoded from the bitstream when the intra prediction mode of the decoding unit is the non-regular mode;

In some embodiments, the first indication information is not decoded from the bitstream when the decoding unit uses the adaptive color transform.

In some embodiments, it is determined that the decoding unit does not use the adaptive color transform when the intra luma prediction mode of the decoding unit is the non-regular mode and an intra chroma prediction mode is a derived mode DM.

In some embodiments, it is determined that the intra luma prediction mode of the decoding unit is not the non-regular mode when the decoding unit does not use the adaptive color transform and the intra chroma prediction mode is a derived mode DM.

In some embodiments, when third indication information indicating a block differential pulse coded modulation (BDPCM) chroma mode is decoded, a ratio of a size of the coding unit to a size of a sub-block is taken as a determination condition.

In some embodiments, when the block differential pulse coded modulation (BDPCM) chroma mode is not enabled or selected, information on cross component linear mode CCLM or other regular modes is decoded.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that the non-regular mode and the adaptive color transform in this disclosure do not operate together, so that a non-regular mode or ACT may be reasonably applied, performance of each coding and decoding tool may be ensured, and efficiency of coding and decoding may be improved.

### Embodiments of a Third Aspect

The embodiments of this disclosure provide an image coding and decoding method, with contents identical to those in the embodiments of the first and second aspects being not going to be described herein any further. The embodiment of the third aspect may be implemented in combination with the embodiments of the first and second aspects, or may be implemented separately. And furthermore, the embodiment of this disclosure may be applicable to a coding side and/or a decoding side, and following description shall be given by taking a decoding side as an example.

It was found by the inventors that in the current VVC standards, when information on adaptive color transform (denoted by cu_act_enabled_flag below) is enabled (i.e. cu_act_enabled_flag=1), coding and/or decoding of information such as BDPCM, CCLM, and intra_chroma_pred_mode, etc. will be skipped, reference may be made to tables 2-8 above, and at the coding side and/or the decoding side, such information may be inferred from existing information.

Table 10 schematically shows expressions for inferring these information, and reference may be made to related video standard documents for specific meanings of these contents.

```
TABLE 10
  The chroma intra prediction mode IntraPredModeC[ xCb ][ yCb ] is derived as
follows:
    If cu_act_enabled_flag[ xCb ][ yCb ] is equal to 1, the chroma intra prediction
mode IntraPredModeC[ xCb ][ yCb ] is set equal to lumaIntraPredMode.
    Otherwise, if BdpcmFlag[ xCb ][ yCb ][ 1 ] is equal to 1,
IntraPredModeC[ xCb ] [ yCb ] is set equal to BdpcmDir[ xCb ][ yCb ][ 1 ] ?
INTRA_ANGULAR50 : INTRA_ANGULAR18.
    Otherwise ( cu_act_enabled_flag[ xCb ][ yCb ] is equal to 0 and BdpcmFlag
[ xCb ][ yCb ][ 1 ] is equal to 0 ), the chroma intra prediction mode IntraPredModeC
[ xCb ][ yCb ] isderived using cclm_mode_flag, cclm_mode_idx, intra_chroma_pred_
mode and lumaIntraPredMode.
  When cclm_mode_flag is not present, it is inferred to be equal to 0.
  When intra_chroma_pred_mode is not present, it is inferred to be equal to 0.
```

Table 11 schematically shows examples of inferring these information, and reference may be made to related video standard documents for specific meanings of these contents.

TABLE 11

| | | | lumaIntraPredMode | | | | |
|---|---|---|---|---|---|---|---|
| cclm_mode_flag | cclm_mode_idx | intra_chroma_pred_mode | | 0 | 8 | | X |
| 0 (planar) | — | 0 | 6 | | | | 0 |
| 0 | — | 1 | 0 | 6 | 0 | 0 | 50 |
| 0 | — | 2 | 8 | 8 | 6 | 8 | 18 |
| 0 | — | 3 | | | | 6 | 1 |
| 0 (DM) | — | 4 | | 0 | 8 | | X |
| 1 | 0 | — | 1 | 1 | 1 | 1 | 81 |
| 1 | 1 | — | 2 | 2 | 2 | 2 | 82 |
| 1 | 2 | — | 3 | 3 | 3 | 3 | 83 |

where, 0≤X≤66, the first row corresponds to the Planar mode, and the fifth row corresponds to the DM mode.

FIG. 5 is a schematic diagram of inferring prediction information in VVC. As shown in FIG. 5, when cu_act_enabled_flag is 1, it may be determined (or inferred) that IntraPredModeC=lumalntraPredMode; otherwise, BdpcmFlag is further inferred. When BdpcmFlag is not equal to 1, IntraPredModeC is inferred by using cclm_mode_flag, cclm_mode_idx, intra_chroma_pred_mode and lumalntraPredMode; otherwise, BdpcmDir is further inferred, in a case of BdpcmDir=1, IntraPredModeC=INTRA_ANGULAR50, and in a case that BdpcmDir is not 1, IntraPredModeC=INTRA_ANGULAR18.

However, it was found by the inventors that the above solution reduces consistency of the decoding process, and is not conducive to hardware design.

In the embodiments of this disclosure, the information on the adaptive color transform may not be determined, and the intra chroma prediction mode of the decoding unit may be determined according to the information of the block differential pulse code modulation (BDPCM) mode.

In addition, in a case where there exists no identification information of a CCLM, the identification information of the CCLM is inferred to be 0; and in a case where there exists no information on an intra chroma prediction mode, the information on the intra chroma prediction mode is inferred to be 4.

Table 12 schematically shows expressions of inferring these information, and reference may be made to related video standard documents for specific meanings of these contents. And furthermore, Table 12 shows differences from Table 10.

```
TABLE 12
  The chroma intra prediction mode IntraPredModeC[ xCb ][ yCb ] is derived as
follows:
    if BdpcmFlag[ xCb ][ yCb ][ 1 ] is equal to 1, IntraPredModeC[ xCb ] [ yCb ] is
set equal to BdpcmDir[ xCb ][ yCb ][ 1 ] ? INTRA_ANGULAR50 : INTRA_
ANGULAR18.
    Otherwise ( BdpcmFlag [ xCb ][ yCb ][ 1 ] is equal to 0 ), the chroma intra
prediction mode IntraPredModeC [ xCb ][ yCb ] is derived using cclm_mode_flag,
cclm_mode_idx, intra_chroma_pred_mode and lumaIntraPredMode.
  When cclm_mode_flag is not present, it is inferred to be equal to 0.
  When intra_chroma_pred_mode is not present, it is inferred to be equal to [symbol]
```

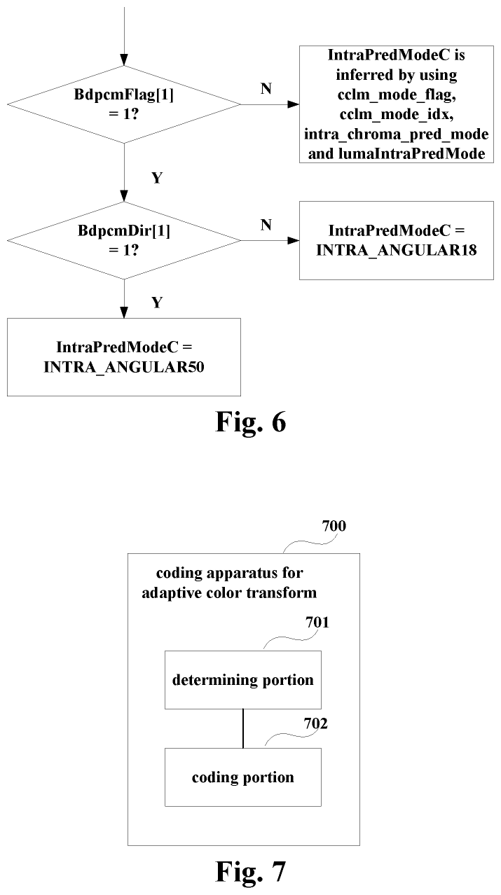

FIG. 6 is a schematic diagram of inferring prediction information in the embodiment of this disclosure. As shown in FIG. 6, it is not needed to determine the information cu_act_enabled_flag of the adaptive color transform, and BdpcmFlag is directly determined; when BdpcmFlag is not equal to 1, IntraPredModeC is inferred by using cclm_mode_flag, cclm_mode_idx, intra_chroma_pred_mode and lumalntraPredMode; otherwise, BdpcmDir is further determined, IntraPredModeC=INTRA_ANGULAR50 when BdpcmDir=1, and IntraPredModeC=INTRA_ANGULAR18 when BdpcmDir is not 1.

Therefore, the chroma prediction mode may be inferred with no need of ACT information, which may improve consistency of the decoding process, and is also beneficial to hardware design.

### Embodiments of a Fourth Aspect

The embodiments of this disclosure provide a coding apparatus for adaptive color transform, with contents identical to those in the embodiments of the first and third aspects being not going to be described herein any further.

FIG. 7 is a schematic diagram of the coding apparatus for adaptive color transform of the embodiment of this disclosure. As shown in FIG. 7, the coding apparatus 700 for adaptive color transform includes:

a determining portion 701 configured to determine that a coding unit does not use adaptive color transform when an intra luma prediction mode of the coding unit is a non-regular mode, or determine that the intra luma prediction mode of the coding unit is not the non-regular mode when the coding unit uses adaptive color transform; and

a coding portion 702 configured to code first indication information indicating whether the intra luma prediction mode of the coding unit is the non-regular mode and/or second indication information indicating whether the coding unit uses the adaptive color transform into a bitstream.

In some embodiments, the non-regular mode is a prediction mode other than 67 regular modes in versatile video coding (VVC), the 67 regular modes including DC, planar and 65 angle modes. For example, the non-regular mode includes at least one of an intra-block copy IBC mode, a matrix-weighted intra prediction MIP mode or a block differential pulse coded modulation BDPCM mode, or any combination thereof.

In some embodiments, the first indication information includes at least one or any combination of the following: intra_bdpcm_luma_flag, intra_mip_flag, or pred_mode_ibc_flag; and the second indication information is cu_act_enabled_flag.

In some embodiments, the coding portion 702 codes the second indication information before coding the intra luma prediction mode of the coding unit.

In some embodiments, the coding portion 702 codes the second indication information after coding an intra chroma prediction mode of the coding unit.

In some embodiments, the coding portion 702 does not code the second indication information into the bitstream when the intra luma prediction mode of the coding unit is the non-regular mode;

In some embodiments, the coding portion 702 does not code the first indication information into the bitstream when the coding unit uses the adaptive color transform.

In some embodiments, the determining portion 701 is further configured to determine that the coding unit does not use the adaptive color transform when the intra luma prediction mode of the coding unit is the non-regular mode and an intra chroma prediction mode is a derived mode (DM).

In some embodiments, the determining portion 701 is further configured to determine that the intra luma prediction mode of the coding unit is not the non-regular mode when the coding unit does not use the adaptive color transform and the intra chroma prediction mode is a derived mode (DM).

In some embodiments, the determining portion 701 does not determine information on the adaptive color transform, and determines an intra chroma prediction mode of the coding unit according to information on a block differential pulse coded modulation (BDPCM) mode.

In some embodiments, in a case where there exists no identification information of a cross component linear mode (CCLM), the identification information of the cross component linear mode (CCLM) is inferred to be 0; and in a case where there exists no information on an intra chroma prediction mode, the information on the intra chroma prediction mode is inferred to be 4.

In some embodiments, when the coding portion 701 codes third indication information indicating a block differential pulse coded modulation (BDPCM) chroma mode, it takes a ratio of a size of the coding unit to a size of a sub-block as a determination condition.

In some embodiments, when the block differential pulse coded modulation (BDPCM) chroma mode is not enabled or selected, it codes information on a cross component linear mode (CCLM) or other regular modes.

It should be noted that the components or modules related to this disclosure are only described above. However, this disclosure is not limited thereto, and the coding apparatus 700 for adaptive color transform may further include other components or modules, and reference may be made to related techniques for particulars of these components or modules.

Furthermore, for the sake of simplicity, connection relationships between the components or modules or signal profiles thereof are only illustrated in FIG. 7. However, it should be understood by those skilled in the art that such related techniques as bus connection, etc., may be adopted. And the above components or modules may be implemented by hardware, such as a processor, or a memory, etc., which are not limited in the embodiment of this disclosure.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiments that the non-regular mode and the adaptive color transform in this disclosure do not operate together, so that a non-regular mode or ACT may be reasonably applied, performance of each coding and decoding tool may be ensured, and efficiency of coding and decoding may be improved.

### Embodiments of a Fifth Aspect

The embodiments of this disclosure provide a decoding apparatus for adaptive color transform, with contents identical to those in the embodiments of the second and third aspects being not going to be described herein any further.

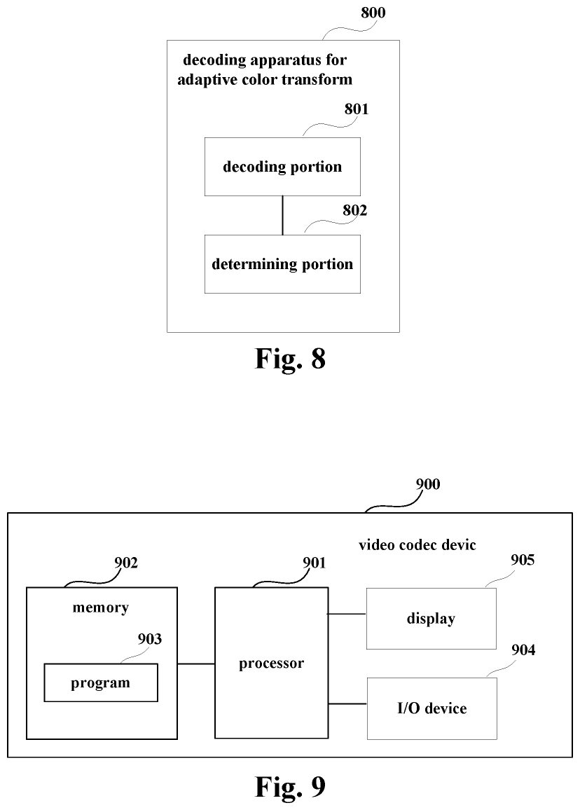

FIG. 8 is a schematic diagram of the decoding apparatus for adaptive color transform of the embodiment of this disclosure. As shown in FIG. 8, the decoding apparatus 800 for adaptive color transform includes:

a decoding portion 801 configured to decode, from a bitstream, first indication information indicating whether an intra luma prediction mode of a decoding unit is a non-regular mode and/or second indication information indicating whether the decoding unit uses adaptive color transform; and

a determining portion 802 configured to determine that the decoding unit does not use adaptive color transform when an intra luma prediction mode of the decoding unit is the non-regular mode, or determine that the intra luma prediction mode of the decoding unit is not the non-regular mode when the decoding unit uses the adaptive color transform.

In some embodiments, the non-regular mode is a prediction mode other than 67 regular modes in versatile video coding (VVC), the 67 regular modes including DC, planar and 65 angle modes. For example, the non-regular mode includes at least one of an intra-block copy IBC mode, a matrix-weighted intra prediction MIP mode or a block differential pulse coded modulation BDPCM mode, or any combination thereof.

In some embodiments, the first indication information includes at least one or any combination of the following: intra_bdpcm_luma_flag, intra_mip_flag, or pred_mode_ibc_flag, and the second indication information is cu_act_enabled_flag.

In some embodiments, the decoding portion 801 decodes the second indication information before decoding the intra luma prediction mode of the decoding unit.

In some embodiments, the decoding portion 801 decodes the second indication information after decoding an intra chroma prediction mode of the decoding unit.

In some embodiments, the decoding portion 801 does not decode the second indication information from the bitstream when the intra luma prediction mode of the decoding unit is the non-regular mode.

In some embodiments, the decoding portion 801 does not decode the first indication information from the bitstream when the decoding unit uses the adaptive color transform.

In some embodiments, the determining portion 802 is further configured to determine that the decoding unit does not use the adaptive color transform when the intra luma prediction mode of the decoding unit is the non-regular mode and an intra chroma prediction mode is a derived mode (DM).

In some embodiments, the determining portion 802 is further configured to determine that the intra luma prediction mode of the decoding unit is not the non-regular mode when the decoding unit does not use the adaptive color transform and the intra chroma prediction mode is a derived mode (DM).

In some embodiments, the determining portion 802 does not determine information on the adaptive color transform, and determines an intra chroma prediction mode of the decoding unit according to information on a block differential pulse coded modulation (BDPCM) mode.

In some embodiments, in a case where there exists no identification information of a cross component linear mode (CCLM), the identification information of the cross component linear mode (CCLM) is inferred to be 0; and in a case where there exists no information on an intra chroma prediction mode, the information on the intra chroma prediction mode is inferred to be 4.

In some embodiments, when the decoding portion 801 decodes third indication information indicating a block differential pulse coded modulation (BDPCM) chroma mode, it takes a ratio of a size of the coding unit to a size of a sub-block as a determination condition.

In some embodiments, when the block differential pulse coded modulation (BDPCM) chroma mode is not enabled or selected, the decoding portion 801 decodes information on cross component linear mode (CCLM) or other regular modes.

It should be noted that the components or modules related to this disclosure are only described above. However, this disclosure is not limited thereto, and the decoding apparatus 800 for adaptive color transform may further include other components or modules, and reference may be made to related techniques for particulars of these components or modules.

Furthermore, for the sake of simplicity, connection relationships between the components or modules or signal profiles thereof are only illustrated in FIG. 8. However, it should be understood by those skilled in the art that such related techniques as bus connection, etc., may be adopted. And the above components or modules may be implemented by hardware, such as a processor, or a memory, etc., which are not limited in the embodiment of this disclosure.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiments that the non-regular mode and the adaptive color transform in this disclosure do not operate together, so that a non-regular mode or ACT may be reasonably applied, performance of each coding and decoding tool may be ensured, and efficiency of coding and decoding may be improved.

### Embodiments of a Sixth Aspect

The embodiments of this disclosure provide a video codec device. The video codec device performs image processing or video processing, and may be a coder of a coding side, or a decoder of a decoding side, or a device including a coder and a decoder.

In some embodiments, the video codec device may include:

a coder configured to determine that a coding unit does not use adaptive color transform when an intra luma prediction mode of the coding unit is an non-regular mode, or determine that the intra luma prediction mode of the coding unit is not the non-regular mode when the coding unit uses adaptive color transform, and code first indication information indicating whether the intra luma prediction mode of the coding unit is the non-regular mode and/or second indication information indicating whether the coding unit uses the adaptive color transform into a bitstream; and

a decoder configured to decode, from a bitstream, the first indication information and/or the second indication information, and determine that a decoding unit does not use adaptive color transform when an intra luma prediction mode of the decoding unit is the non-regular mode, or determine that the intra luma prediction mode of the decoding unit is not the non-regular mode when the decoding unit uses the adaptive color transform.

FIG. 9 is a schematic diagram of the video codec device of the embodiment of this disclosure. As shown in FIG. 9, the video codec device 900 may include a processor 901 and a memory 920, the memory 902 being coupled to the processor 901. The memory 902 may store various data, and furthermore, it may store a program 903 for information processing, and execute the program 903 under control of the processor 901.

In some embodiments, the functions of the coding apparatus 700 for adaptive color transform may be integrated into the processor 901. The processor 901 may be configured to carry out the coding method for adaptive color transform as described in the embodiment of the first aspect.

For example, the processor 901 may be configured to perform the following control: determining that a coding unit does not use adaptive color transform when an intra luma prediction mode of the coding unit is a non-regular mode, or determining that the intra luma prediction mode of the coding unit is not the non-regular mode when the coding unit uses adaptive color transform; and coding first indication information indicating whether the intra luma prediction mode of the coding unit is the non-regular mode and/or second indication information indicating whether the coding unit uses the adaptive color transform into a bitstream.

In some embodiments, the functions of the decoding apparatus 800 for adaptive color transform may be integrated into the processor 901. Wherein, the processor 901 may be configured to carry out the decoding method for adaptive color transform as described in the embodiment of the second aspect.

For example, the processor 901 may be configured to perform the following control: decoding, from a bitstream, first indication information indicating whether an intra luma prediction mode of a decoding unit is a non-regular mode and/or second indication information indicating whether the decoding unit uses adaptive color transform; and determining that the decoding unit does not use adaptive color transform when an intra luma prediction mode of the decoding unit is the non-regular mode, or determining that the intra luma prediction mode of the decoding unit is not the non-regular mode when the decoding unit uses the adaptive color transform.

In some embodiments, the processor 901 may be configured to carry out the image coding and decoding method as described in the embodiments of the first and second aspects. For example, the processor 901 may be configured to perform the following control: in coding and/or decoding indication information indicating a block differential pulse coded modulation (BDPCM) chroma mode, taking a ratio of a size of a coding unit or a decoding unit to a size of a sub-block as a determination condition; and when the block differential pulse coded modulation (BDPCM) chroma mode is not enabled or selected, coding information on a cross component linear mode (CCLM) or other regular modes.

In some embodiments, the processor 901 may be configured to carry out the image coding and decoding method as described in the embodiment of the third aspect. For example, the processor 901 may be configured to perform the following control: not determining information on the adaptive color transform, and determining an intra chroma prediction mode of a coding unit or a decoding unit according to information on a block differential pulse coded modulation (BDPCM) mode; in a case where there exists no identification information of a cross component linear mode (CCLM), inferring the identification information of the cross component linear mode to be 0; and in a case where there exists no information on an intra chroma prediction mode, inferring the information on the intra chroma prediction mode to be 4.

Furthermore, as shown in FIG. 9, the video codec device 900 may further include an input/output (I/O) device 904, and a display 905, etc.; wherein, functions of the above components are similar to those in the prior art, and shall not be described herein any further. It should be noted that the video codec device 900 does not necessarily include all the parts shown in FIG. 9, and furthermore, the video codec device 900 may include parts not shown in FIG. 9, such as a camera, and a hard disk driver (HDD), etc., and related technologies may be referred to.

An embodiment of the present disclosure provides a computer readable program, which, when executed in a video codec device or an electronic device, will cause the video codec device or the electronic device to carry out the coding method for adaptive color transform described in the embodiment of the first aspect.

An embodiment of the present disclosure provides a computer storage medium, including a computer readable program, which will cause a video codec device or an electronic device to carry out the coding method for adaptive color transform described in the embodiment of the first aspect.

An embodiment of the present disclosure provides a computer readable program, which, when executed in a video codec device or an electronic device, will cause the video codec device or the electronic device to carry out the decoding method for adaptive color transform described in the embodiment of the second aspect.

An embodiment of the present disclosure provides a computer storage medium, including a computer readable program code, which will cause a video codec device or an electronic device to carry out the decoding method for adaptive color transform described in the embodiment of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations including the above embodiments, supplements are further disclosed below:

Supplement 1. A coding method for adaptive color transform, including:

determining that a coding unit does not use adaptive color transform when an intra luma prediction mode of the coding unit is a non-regular mode, or determining that the intra luma prediction mode of the coding unit is not the non-regular mode when the coding unit uses adaptive color transform; and

coding first indication information indicating whether the intra luma prediction mode of the coding unit is the non-regular mode and/or second indication information indicating whether the coding unit uses the adaptive color transform into a bitstream.

Supplement 2. The coding method according to supplement 1, wherein the non-regular mode is a prediction mode other than 67 regular modes in versatile video coding (VVC), the 67 regular modes including DC, planar and 65 angle modes.

Supplement 3. The coding method according to supplement 1 or 2, wherein the non-regular mode includes at least one of an intra-block copy (IBC) mode, a matrix-weighted intra prediction (MIP) mode or a block differential pulse coded modulation (BDPCM) mode, or any combination thereof.

Supplement 4. The coding method according to any one of supplements 1-3, wherein the first indication information includes at least one or any combination of the following: intra_bdpcm_luma_flag, intra_mip_flag, or pred_mode_ibc_flag; and the second indication information is cu_act_enabled_flag.

Supplement 5. The coding method according to any one of supplements 1-4, the second indication information is coded before the intra luma prediction mode of the coding unit is coded;

Supplement 6. The coding method according to any one of supplements 1-4, the second indication information is coded after an intra chroma prediction mode of the coding unit is coded.

Supplement 7. The coding method according to any one of supplements 1-6, wherein the second indication information is not coded into the bitstream when the intra luma prediction mode of the coding unit is the non-regular mode.

Supplement 8. The coding method according to any one of supplements 1-6, the first indication information is not coded into the bitstream when the coding unit uses the adaptive color transform.

Supplement 9. The coding method according to any one of supplements 1-8, wherein it is determined that the coding unit does not use the adaptive color transform when the intra luma prediction mode of the coding unit is the non-regular mode and an intra chroma prediction mode is a derived mode (DM).

Supplement 10. The coding method according to any one of supplements 1-8, wherein it is determined that the intra luma prediction mode of the coding unit is not the non-regular mode when the coding unit does not use the adaptive color transform and the intra chroma prediction mode is a derived mode (DM).

Supplement 11. The coding method according to any one of supplements 1-10, wherein information on the adaptive color transform is not determined, and an intra chroma prediction mode of the coding unit is determined according to information on a block differential pulse coded modulation (BDPCM) mode.

Supplement 12. The coding method according supplement 11, wherein in a case where there exists no identification information of a cross component linear mode (CCLM), the identification information of the cross component linear mode (CCLM) is inferred to be 0; and in a case where there exists no information on an intra chroma prediction mode, the information on the intra chroma prediction mode is inferred to be 4.

Supplement 13. The coding method according to any one of supplements 1-12, wherein when third indication information indicating a block differential pulse coded modulation (BDPCM) chroma mode is coded, a ratio of a size of the coding unit to a size of a sub-block is taken as a determination condition.

Supplement 14. The coding method according to supplement 13, wherein when the block differential pulse coded modulation (BDPCM) chroma mode is not enabled or selected, information on a cross component linear mode (CCLM) or other regular modes is coded.

Supplement 15. A decoding method for adaptive color transform, including:

decoding, from a bitstream, first indication information indicating whether an intra luma prediction mode of a decoding unit is a non-regular mode and/or second indication information indicating whether the decoding unit uses adaptive color transform; and

determining that the decoding unit does not use adaptive color transform when an intra luma prediction mode of the decoding unit is the non-regular mode, or determining that the intra luma prediction mode of the decoding unit is not the non-regular mode when the decoding unit uses the adaptive color transform.

Supplement 16. The decoding method according to supplement 15, wherein the non-regular mode is a prediction mode other than 67 regular modes in versatile video coding (VVC), the 67 regular modes including DC, planar and 65 angle modes.

Supplement 17. The decoding method according to supplement 15 or 16, wherein the non-regular mode includes at least one of an intra-block copy (IBC) mode, a matrix-weighted intra prediction (MIP) mode or a block differential pulse coded modulation (BDPCM) mode, or any combination thereof.

Supplement 18. The decoding method according to any one of supplements 15-17, wherein the first indication information includes at least one or any combination of the following: intra_bdpcm_luma_flag, intra_mip_flag, or pred_mode_ibc_flag, and the second indication information is cu_act_enabled_flag.

Supplement 19. The decoding method according to any one of supplements 15-18, wherein the second indication information is decoded before the intra luma prediction mode of the decoding unit is decoded.

Supplement 20. The decoding method according to any one of supplements 15-18, wherein the second indication information is decoded after an intra chroma prediction mode of the decoding unit is decoded.

Supplement 21. The decoding method according to any one of supplements 15-20, wherein the second indication information is not decoded from the bitstream when the intra luma prediction mode of the decoding unit is the non-regular mode;

Supplement 22. The decoding method according to any one of supplements 15-20, wherein the first indication information is not decoded from the bitstream when the decoding unit uses the adaptive color transform.

Supplement 23. The decoding method according to any one of supplements 15-22, wherein it is determined that the decoding unit does not use the adaptive color transform when the intra luma prediction mode of the decoding unit is the non-regular mode and an intra chroma prediction mode is a derived mode (DM).

Supplement 24. The decoding method according to any one of supplements 15-22, wherein it is determined that the intra luma prediction mode of the decoding unit is not the non-regular mode when the decoding unit does not use the adaptive color transform and the intra chroma prediction mode is a derived mode (DM).

Supplement 25. The decoding method according to any one of supplements 15-24, wherein information on the adaptive color transform is not determined, and an intra chroma prediction mode of the decoding unit is determined according to information on a block differential pulse coded modulation (BDPCM) mode.

Supplement 26. The decoding method according to supplement 25, wherein in a case where there exists no identification information of a cross component linear mode (CCLM), the identification information of the cross component linear mode (CCLM) is inferred to be 0; and in a case where there exists no information on an intra chroma prediction mode, the information on the intra chroma prediction mode is inferred to be 4.

Supplement 27. The decoding method according to any one of supplements 15-26, wherein when third indication information indicating a block differential pulse coded modulation (BDPCM) chroma mode is decoded, a ratio of a size of the coding unit to a size of a sub-block is taken as a determination condition.

Supplement 28. The decoding method according to supplement 27, wherein when the block differential pulse coded modulation (BDPCM) chroma mode is not enabled or selected, information on cross component linear mode (CCLM) or other regular modes is decoded.

Supplement 29. An image coding and decoding method, including: in coding and/or decoding indication information indicating a block differential pulse coded modulation chroma mode BDPCM, taking a ratio of a size of a coding unit or a decoding unit to a size of a sub-block as a determination condition

Supplement 30. The coding and decoding method according to supplement 29, wherein when the block differential pulse coded modulation chroma (BDPCM) mode is not enabled or selected, information on a cross component linear mode (CCLM) or other regular modes is coded or decoded.

Supplement 31. An image coding and decoding method, including:

not determining information on adaptive color transform, and determining an intra chroma prediction mode of a coding unit or a decoding unit according to information on a block differential pulse coded modulation (BDPCM) mode.

Supplement 32. The coding and decoding method according to supplement 31, wherein in a case where there exists no identification information of a cross component linear mode (CCLM), the identification information of the cross component linear mode (CCLM) is inferred to be 0; and in a case where there exists no information on an intra chroma prediction mode, the information on the intra chroma prediction mode is inferred to be 4.

What is claimed is:

1. A coding apparatus for adaptive color transform, comprising:
a processor configured to:
determine that a coding unit does not use adaptive color transform when an intra luma prediction mode of the coding unit is a non-regular mode, or determine that the intra luma prediction mode of the coding unit is not the non-regular mode when the coding unit uses adaptive color transform; and
code first indication information indicating whether the intra luma prediction mode of the coding unit is the non-regular mode and/or second indication information indicating whether the coding unit uses the adaptive color transform into a bitstream.

2. The coding apparatus according to claim 1, wherein the non-regular mode is a prediction mode other than 67 regular modes in versatile video coding, the 67 regular modes comprising DC, planar and 65 angle modes.

3. The coding apparatus according to claim 1, wherein the non-regular mode comprises at least one of an intra-block copy mode, a matrix-weighted intra prediction mode or a block differential pulse coded modulation mode, or any combination thereof.

4. The coding apparatus according to claim 1, wherein the first indication information comprises at least one or any combination of the following: intra_bdpcm_luma_flag, intra_mip_flag, or pred_mode_ibc_flag; and the second indication information is cu_act_enabled_flag.

5. The coding apparatus according to claim 1, wherein the processor codes the second indication information before coding the intra luma prediction mode of the coding unit, or
the processor codes the second indication information after coding an intra chroma prediction mode of the coding unit.

6. The coding apparatus according to claim 1, wherein the processor does not code the second indication information into the bitstream when the intra luma prediction mode of the coding unit is the non-regular mode, or
the processor does not code the first indication information into the bitstream when the coding unit uses the adaptive color transform.

7. The coding apparatus according to claim 1, wherein the processor is further configured to determine that the coding unit does not use the adaptive color transform when the intra luma prediction mode of the coding unit is the non-regular mode and an intra chroma prediction mode is a derived mode, or
the processor is further configured to determine that the intra luma prediction mode of the coding unit is not the non-regular mode when the coding unit does not use the adaptive color transform and the intra chroma prediction mode is a derived mode.

8. The coding apparatus according to claim 1, wherein the processor does not determine information on the adaptive color transform, and determines an intra chroma prediction mode of the coding unit according to information on a block differential pulse coded modulation mode.

9. The coding apparatus according to claim 8, wherein in a case where there exists no identification information of a cross component linear mode, the identification information of the cross component linear mode is inferred to be 0; and
in a case where there exists no information on an intra chroma prediction mode, the information on the intra chroma prediction mode is inferred to be 4.

10. The coding apparatus according to claim 1, wherein when the processor codes third indication information indicating a block differential pulse coded modulation chroma mode, the processor takes a ratio of a size of the coding unit to a size of a sub-block as a determination condition, and
when the block differential pulse coded modulation chroma mode is not enabled or selected, the processor codes information on a cross component linear mode or other regular modes.

11. A decoding apparatus for adaptive color transform, comprising:
a processor configured to:
decode, from a bitstream, first indication information indicating whether an intra luma prediction mode of a decoding unit is a non-regular mode and/or second indication information indicating whether the decoding unit uses adaptive color transform; and
determine that the decoding unit does not use adaptive color transform when an intra luma prediction mode of the decoding unit is the non-regular mode, or determine that the intra luma prediction mode of the decoding unit is not the non-regular mode when the decoding unit uses the adaptive color transform.

12. The decoding apparatus according to claim 11, wherein the non-regular mode is a prediction mode other than 67 regular modes in versatile video coding, the 67 regular modes comprising DC, planar and 65 angle modes.

13. The decoding apparatus according to claim 11, wherein the non-regular mode comprises at least one of an intra-block copy mode, a matrix-weighted intra prediction mode or a block differential pulse coded modulation mode, or any combination thereof.

14. The decoding apparatus according to claim 11, wherein the first indication information comprises at least one or any combination of the following: intra_bdpcm_luma_flag, intra_mip_flag, or pred_mode_ibc_flag, and the second indication information is cu_act_enabled_flag.

15. The decoding apparatus according to claim 11, wherein the processor decodes the second indication information before decoding the intra luma prediction mode of the decoding unit, or
the processor decodes the second indication information after decoding an intra chroma prediction mode of the decoding unit.

16. The decoding apparatus according to claim 11, wherein the processor does not decode the second indication information from the bitstream when the intra luma prediction mode of the decoding unit is the non-regular mode, or
the processor does not decode the first indication information from the bitstream when the decoding unit uses the adaptive color transform.

17. The decoding apparatus according to claim 11, wherein the processor is further configured to determine that the decoding unit does not use the adaptive color transform when the intra luma prediction mode of the decoding unit is the non-regular mode and an intra chroma prediction mode is a derived mode, or
the processor is further configured to determine that the intra luma prediction mode of the decoding unit is not the non-regular mode when the decoding unit does not use the adaptive color transform and the intra chroma prediction mode is a derived mode.

18. The decoding apparatus according to claim 11, wherein the processor does not determine information on the adaptive color transform, and determines an intra chroma prediction mode of the decoding unit according to information on a block differential pulse coded modulation mode;
in a case where there exists no identification information of a cross component linear mode, the identification information of the cross component linear mode is inferred to be 0; and
in a case where there exists no information on an intra chroma prediction mode, the information on the intra chroma prediction mode is inferred to be 4.

19. The decoding apparatus according to claim 11, wherein when the processor decodes third indication information indicating a block differential pulse coded modulation chroma mode, the processor takes a ratio of a size of the decoding unit to a size of a sub-block as a determination condition;
and when the block differential pulse coded modulation chroma mode is not enabled or selected, the processor decodes information on cross component linear mode or other regular modes.

20. A video codec device, comprising:
a coder configured to determine that a coding unit does not use adaptive color transform when an intra luma prediction mode of the coding unit is an non-regular mode, or determine that the intra luma prediction mode of the coding unit is not the non-regular mode when the coding unit uses adaptive color transform, and code first indication information indicating whether the intra luma prediction mode of the coding unit is the non-regular mode and/or second indication information indicating whether the coding unit uses the adaptive color transform into a bitstream; and
a decoder configured to decode, from a bitstream, the first indication information and/or the second indication information, and determine that a decoding unit does not use adaptive color transform when an intra luma prediction mode of the decoding unit is the non-regular mode, or determine that the intra luma prediction mode of the decoding unit is not the non-regular mode when the decoding unit uses the adaptive color transform.
